(19) United States
(12) Patent Application Publication
(10) Pub. No.: US 2026/0170359 A1
(43) Pub. Date: Jun. 18, 2026

(54) LEARNING APPARATUS

(71) Applicant: NEC Corporation, Minato-ku, Tokyo (JP)

(72) Inventor: Junki MORI, Tokyo (JP)

(73) Assignee: NEC Corporation, Minato-ku, Tokyo (JP)

(21) Appl. No.: 18/711,973

(22) PCT Filed: Dec. 2, 2021
(86) PCT No.: PCT/JP2021/044305

§ 371 Date: May 21, 2024

(51) Int. Cl. G06N 5/04

(52) U.S. Cl. CPC G06N 5/04

(57) ABSTRACT

A learning apparatus 500 includes a common model learning unit 521 configured to learn a common model, which is also used by an other learning apparatus, using a common feature, which is a feature owned in common with the other learning apparatus, among features owned by this learning apparatus 500, and a specific model learning unit 522 configured to learn a specific model, which is a model specific to this learning apparatus 500, using a specific feature, which is a feature not owned in common with the other learning apparatus, among the features owned by this learning apparatus 500 based on the common model learned by the common model learning unit 521.

### TECHNICAL FIELD

The present invention relates to a learning apparatus, a learning method, a recording medium, and a learning system.

### BACKGROUND ART

There are known techniques used at the time of learning using learning data.

For example, Patent Literature 1 discloses a learning apparatus including a data generator and an incremental learner that incrementally learns a learned model using incremental training data generated by the data generator. Note that the incremental learning can also be called continual learning as described in Patent Literature 1.

### CITATION LIST

### Patent Literature

[Patent Literature 1] International Publication No. 2020/194500

### SUMMARY OF INVENTION

### Technical Problem

There is a technique called federated learning, in which a plurality of clients trains a machine learning model in cooperation with one another without directly exchanging features used as learning data that are owned by the clients, respectively. One type of such federated learning is learning called horizontal federated learning, in which the learning is conducted using a feature owned in common by each of the clients. In this regard, a problem has arisen in that, among the features owned by the clients, a feature in a portion not in common among the clients cannot be utilized when the horizontal federated learning is conducted.

Under these circumstances, an object of the present invention is to provide a learning apparatus, a learning method, a recording medium, and a learning system capable of solving such a problem that there is a feature unusable when horizontal federated learning is conducted.

### Solution to Problem

To achieve the above-described object, according to one aspect of the present disclosure, a learning apparatus includes
a common model learning unit configured to learn a common model using a common feature among features owned by this learning apparatus, the common model being also used by an other learning apparatus, the common feature being a feature owned in common with the other learning apparatus, and
a specific model learning unit configured to learn a specific model using a specific feature among the features owned by this learning apparatus based on the common model learned by the common model learning unit, the specific model being a model specific to this learning apparatus, the specific feature being a feature not owned in common with the other learning apparatus.

Further, according to another aspect of the present disclosure, a learning method includes
causing an information processing apparatus to
learn a common model using a common feature among features owned by this information processing apparatus, the common model being also used by an other learning apparatus, the common feature being a feature owned in common with the other learning apparatus, and
learn a specific model using a specific feature among the features owned by this information processing apparatus based on the learned common model, the specific model being a model specific to this information processing apparatus, the specific feature being a feature not owned in common with the other learning apparatus.

Further, according to another aspect of the present disclosure, a non-transitory computer-readable recording medium records thereon a program for realizing processing including
causing an information processing apparatus to
learn a common model using a common feature among features owned by this information processing apparatus, the common model being also used by an other learning apparatus, the common feature being a feature owned in common with the other learning apparatus, and
learn a specific model using a specific feature among the features owned by this information processing apparatus based on the learned common model, the specific model being a model specific to this information processing apparatus, the specific feature being a feature not owned in common with the other learning apparatus.

Further, according to another aspect of the present disclosure, a learning system includes
a learning apparatus including
a common model learning unit configured to learn a common model using a common feature among features owned by this learning apparatus, the common model being also used by an other learning apparatus, the common feature being a feature owned in common with the other learning apparatus, and
a specific model learning unit configured to learn a specific model using a specific feature among the features owned by this learning apparatus based on the common model learned by the common model learning unit, the specific model being a model specific to this learning apparatus, the specific feature being a feature not owned in common with the other learning apparatus, and
a server apparatus including an integration unit configured to, by communicating with a plurality of learning apparatuses, integrate the common model learned by each of the learning apparatuses.

### Advantageous Effects of Invention

According to each of the above-described configurations, it is possible to provide a learning apparatus, a learning method, a recording medium, and a learning system capable of further increasing inference accuracy by utilizing, at the time of learning and inference, a feature unusable when horizontal federated learning is conducted.

### BRIEF DESCRIPTION OF DRAWINGS

FIG. 1 is a diagram illustrating the outline of the present invention.

FIG. 2 is a diagram illustrating an example of the overall configuration of a learning system.

FIG. 3 is a block diagram illustrating an example of the configuration of a learning apparatus.

FIG. 4 is a diagram illustrating one example of learning data.

FIG. 5 illustrates an example of merging learning models.

FIG. 6 is a diagram illustrating an example of the configuration of a server apparatus.

FIG. 7 is a flowchart illustrating an example of an operation of the learning apparatus.

FIG. 8 is a flowchart illustrating an example of the further detailed operation of step S130.

FIG. 9 is a flowchart illustrating an example of another operation of the learning apparatus.

FIG. 10 is a diagram illustrating an example of the hardware configuration of a learning apparatus according to a second exemplary embodiment of the present invention.

FIG. 11 is a block diagram illustrating an example of the configuration of the learning apparatus.

### DESCRIPTION OF EMBODIMENTS

### First Exemplary Embodiment

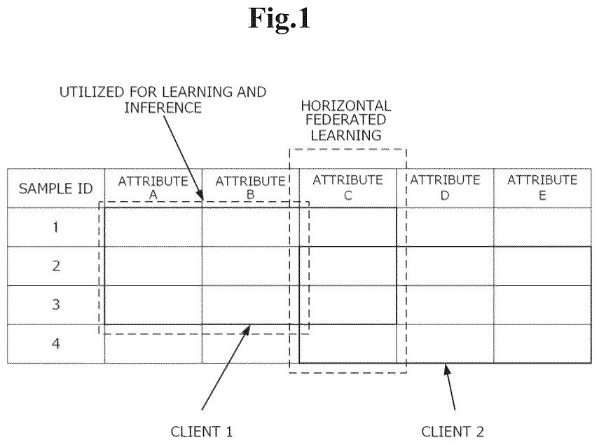

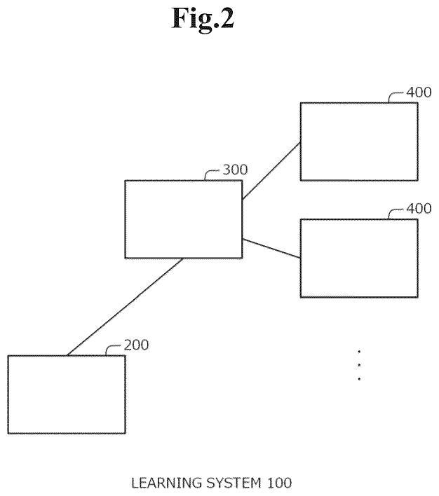

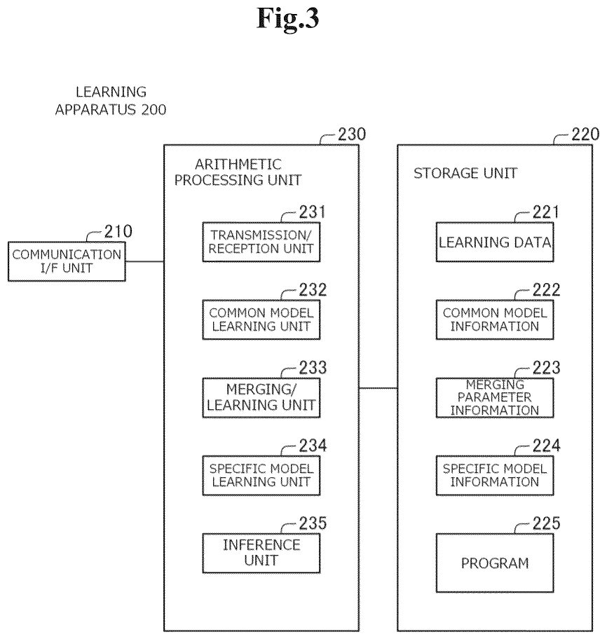

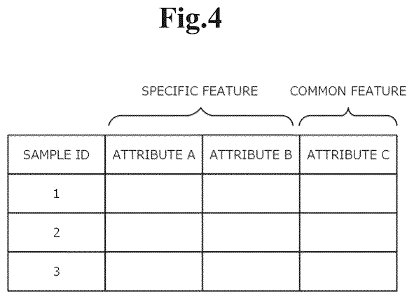

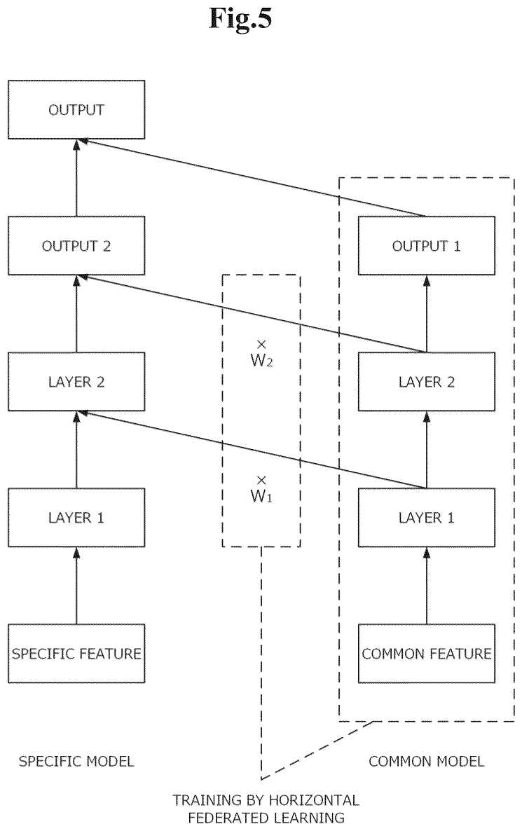

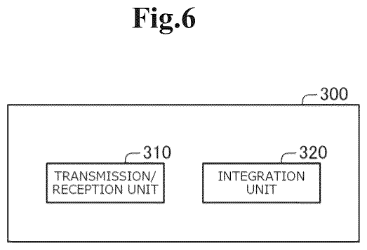

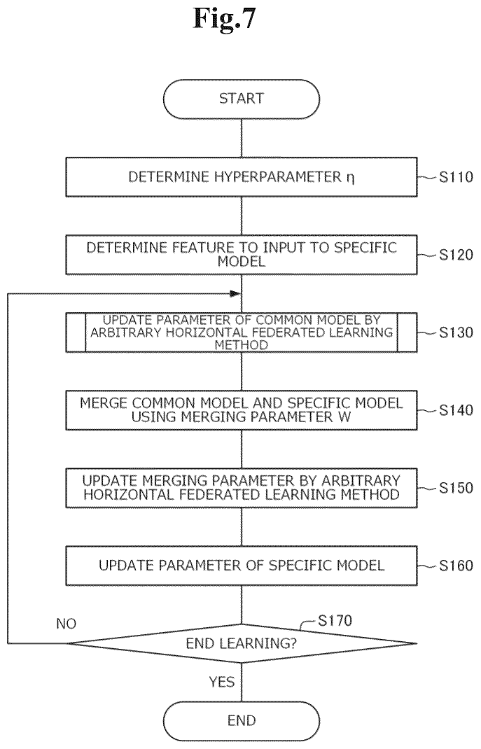

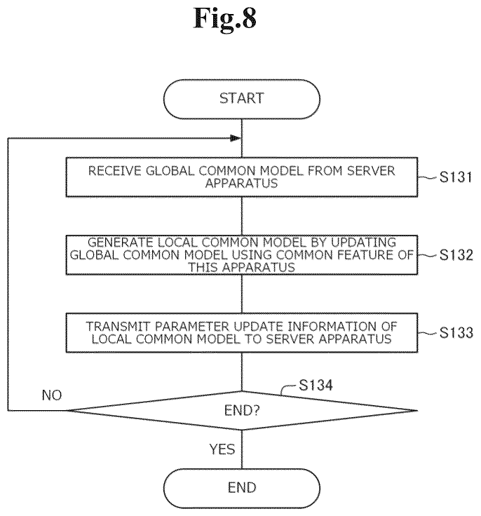

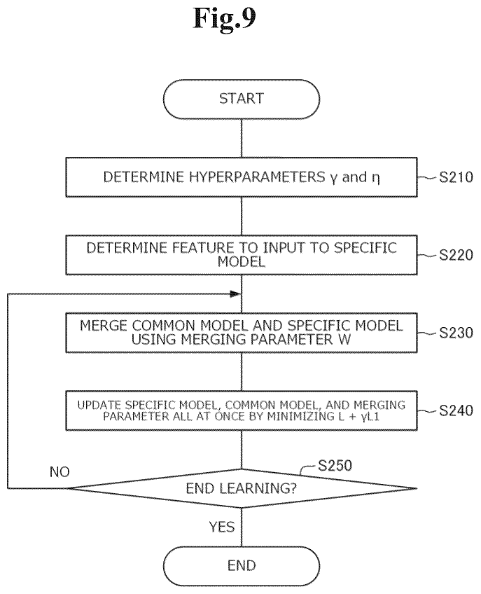

A first exemplary embodiment of the present disclosure will be described with reference to FIGS. 1 to 9. FIG. 1 is a diagram illustrating the outline of the present invention. FIG. 2 is a diagram illustrating an example of the overall configuration of a learning system 100. FIG. 3 is a block diagram illustrating an example of the configuration of a learning apparatus 200. FIG. 4 is a diagram illustrating one example of learning data 221. FIG. 5 is a diagram illustrating an example of merging a common model and a specific model, which are learning models. FIG. 6 is a diagram illustrating an example of the configuration of a server apparatus 300. FIGS. 7 and 8 are flowcharts illustrating examples of operations of the learning apparatus 200. FIG. 9 is a flowchart illustrating an example of another operation of the learning apparatus 200.

A first exemplary embodiment of the present disclosure will be described regarding a learning system 100 including a learning apparatus 200 capable of conducting horizontal federated learning using a common feature, which is a feature owned in common by a plurality of clients, and, along therewith, conducting learning, inference, and the like also utilizing a specific feature, which is a feature specific to this learning apparatus 200. For example, in the case of an example illustrated in FIG. 1, the learning apparatus 200 owns features of a client 1, and another learning apparatus 400 in the learning system 100 owns features of a client 2. In the case of such a configuration, for example, the learning apparatus 200 conducts horizontal federated learning using a feature of an attribute C, which is a common feature, among features of an attribute A, an attribute B, and the attribute C, which are features owned by this learning apparatus 200.

Further, the learning apparatus 200 learns a specific model using at least the specific feature. For example, in the case of FIG. 1, the features of the attribute A and the attribute B are owned by the learning apparatus 200 while not owned by the other learning apparatus 400. Therefore, the learning apparatus 200 learns the specific model using at least the features of the attribute A and the attribute B, which are specific features. Further, in the case of the present exemplary embodiment, the learning apparatus 200 learns the specific model so as to retain an outcome learned by the horizontal federated learning when learning the specific model. For example, the learning apparatus 200 learns the specific model so as to retain the outcome of the horizontal federated learning by applying a continual learning method, such as a method of learning a model of a task 2 by inputting an output of an intermediate layer of a task 1 to each layer after fixing a model parameter acquired by learning the task 1. As a result, the learning apparatus 200 generates a specific model that inherits knowledge of the common model learned by the horizontal federated learning.

FIG. 2 illustrates an example of the overall configuration of the learning system 100. Referring to FIG. 2, the learning system 100 includes the learning apparatus 200, the server apparatus 300, and at least one or more other learning apparatus(es) 400. As illustrated in FIG. 2, the learning apparatus 200 and the server apparatus 300 are connected communicably with each other via a network or the like. Further, the server apparatus 300 and the other learning apparatus(es) 400 are connected communicably with each other via a network or the like.

The learning apparatus 200 is an information processing apparatus that generates the common model in cooperation with the other learning apparatus(es) 400 by the horizontal federated learning using the common feature, and also generates the specific model by the learning using at least the specific feature. FIG. 3 illustrates an example of the configuration of the learning apparatus 200. Referring to FIG. 3, the learning apparatus 200 includes, for example, a communication I/F unit 210, a storage unit 220, and an arithmetic processing unit 230 as main constituent elements thereof.

Note that FIG. 3 illustrates an example when the functions as the learning apparatus 200 are realized using one information processing apparatus. However, the learning apparatus 200 may be realized using a plurality of information processing apparatuses such as being realized on a cloud. Further, the learning apparatus 200 may include a configuration different from the above-described examples, such as an operation input unit such as a keyboard and a mouse, and a screen display unit.

The communication I/F unit 210 is configured of a data communication circuit or the like. The communication I/F unit 210 carries out data communication between the learning apparatus 200 and an external apparatus such as the server apparatus 300 connected via a communication line.

The storage unit 220 is a storage device such as a hard disk or a memory. The storage unit 220 stores processing information required for various kinds of processing performed by the arithmetic processing unit 230, and a program 225 therein. The program 225 realizes the various kinds of processing units by being read in and executed by the arithmetic processing unit 230. The program 225 is read in from an external apparatus or a recording medium in advance via a data input/output function such as the communication I/F unit 210, and is stored in the storage unit 220. Examples of main information stored in the storage unit 220 include learning data 221, common model information 222, merging parameter information 223, and specific model information 224.

The learning data 221 includes a feature such as the common feature and the specific feature, which are data used when the common model and the specific model are learned. The learning data 221 is data in a table format or the like as one example, but may be a feature different from the example. For example, the learning data 221 is acquired in advance from an external apparatus or the like via the communication I/F unit 210 or the like or is input in advance using the operation input unit such as a keyboard or a mouse included in the learning apparatus 200, and is stored in the storage unit 220.

FIG. 4 illustrates one example of the learning data 221. Referring to FIG. 4, the learning data 221 includes the common feature, which is a feature owned in common with the other learning apparatus(es) 400, and the specific feature, which is a feature specific to this learning apparatus 200 that is not owned by the other learning apparatus(es) 400. For example, in the case of the example illustrated in FIG. 4, the learning data 221 includes the features of the attributes A and B, which are specific features, and the feature of the attribute C, which is a common feature.

The common model information 222 includes a model subjected to machine learning processing using the common feature. For example, the common model information 222 is updated according to, for example, reception of the common model, parameter update information, or the like from the server apparatus 300 via the transmission/reception unit 231, or learning conducted by the common model learning unit 232 based on the common feature included in the learning data 221.

Note that the horizontal federated learning is conducted in the present exemplary embodiment as described above. This means that the common model included in the common model information 222 is a model learned using even a common feature not owned by the learning apparatus 200 (for example, a feature of the attribute C identified with a sample ID 4 in FIG. 1) as a result of the horizontal federated learning in which the model is learned in cooperation with the other learning apparatus(es) 400.

The merging parameter information 223 includes a merging parameter such as a matrix used when the common model and the specific model are merged. For example, a merging/learning unit 233 merges an output of an i-th layer of the common model to a j-th layer of the specific model after multiplying the output of the i-th layer of the common model by a matrix Wᵢ and the like, as will be described below. The merging parameter information 223 includes the above-described matrix Wᵢ and the like as the merging parameter. In other words, the merging parameter information 223 includes, for example, a merging parameter for each merging portion. The merging parameter information 223 is updated according to, for example, reception of the merging parameter, parameter update information, or the like from the server apparatus 300 via the transmission/reception unit 231 or the learning conducted by the merging/learning unit 233 based on the common feature, the specific feature, and the like included in the learning data 221.

Note that the merging parameter is also targeted for the horizontal federated learning in the present exemplary embodiment, as will be described below. This means that the merging parameter included in the merging parameter information 223 is a parameter in which a result of the learning conducted by the other learning apparatus(es) 400 different from the learning apparatus 200 is also reflected as a result of the horizontal federated learning conducted in cooperation with the other learning apparatus(es) 400.

The specific model information 224 includes a model subjected to machine learning processing using at least the specific feature. For example, the specific model information 224 is updated according to a result of the learning conducted by the specific model learning unit 234 based on at least the specific feature included in the learning data 221.

Note that the specific model learning unit 234 learns the specific model so as to retain the outcome of the horizontal federated learning in the present exemplary embodiment as described above. This means that the specific model included in the specific model information 224 inherits the knowledge of the common model learned by the horizontal federated learning.

The arithmetic processing unit 230 includes an arithmetic device such as a CPU (Central Processing Unit), and a peripheral circuit thereof. The arithmetic processing unit 230 reads in the program 225 from the storage unit 220 and executes it, thereby causing the above-described hardware and the program 225 to cooperate with each other to realize various kinds of processing units. Examples of main processing units realized by the arithmetic processing unit 230 include the transmission/reception unit 231, the common model learning unit 232, the merging/learning unit 233, the specific model learning unit 234, and an inference unit 235.

The transmission/reception unit 231 transmits/receives data required when the horizontal federated learning is conducted between the learning apparatus 200 and the server apparatus 300.

For example, the transmission/reception unit 231 receives the common model, the parameter update information of the common model, or the like from the server apparatus 300. Then, the transmission/reception unit 231 stores the received common model or the like into the storage unit 220 as the common model information 222.

Further, the transmission/reception unit 231 transmits the parameter update information of the common model or the updated common model to the server apparatus 300. For example, when the common model learning unit 232 updates the common model included in the common model information 222 using the common feature included in the learning data 221, the transmission/reception unit 231 transmits the parameter update information indicating the parameter updated by the learning or the updated common model to the server apparatus 300.

Further, the transmission/reception unit 231 receives the merging parameter or the parameter update information of the merging parameter from the server apparatus. Then, the transmission/reception unit 231 stores the received merging parameter or the like into the storage unit 220 as the merging parameter information 223.

Further, the transmission/reception unit 231 transmits the parameter update information of the merging parameter or the updated merging parameter to the server apparatus. For example, when the merging/learning unit 233 updates the merging parameter included in the merging parameter information 223 using the common feature, the specific feature, and the like included in the learning data 221, the transmission/reception unit 231 transmits the parameter update information indicating the parameter updated by the learning or the updated merging parameter to the server apparatus 300.

The transmission/reception unit 231 transmits/receives the information required to conduct the horizontal federated learning in this manner by way of example. The transmission/reception unit 231, for example, transmits and receives the common model, the parameter update information of the common model, the merging parameter, the parameter update information of the merging parameter, and the like to and from the server apparatus 300.

The common model learning unit 232 generates the common model using the common feature included in the learning data 221. In the case of the present exemplary embodiment, the common model learning unit 232 generates the common model based on the common feature not owned by the learning apparatus 200 by conducting the horizontal federated learning for generating the common model in cooperation with the other learning apparatus(es) 400.

For example, the common model learning unit 232 receives the common model from the server apparatus 300 via the transmission/reception unit 231. Further, the common model learning unit 232 generates a new common model by updating the common model using the common feature included in the learning data 221. Then, the common model learning unit 232 stores the common model updated/generated by the learning into the storage unit 220 as the common model information 222. Further, the common model learning unit 232 transmits, for example, the update parameter information indicating the parameter updated by the learning to the server apparatus 300 via the transmission/reception unit 231. Note that the common model learning unit 232 may repeat the processing of transmitting the update parameter information or the like to the server apparatus 300 after receiving the above-described common model, until the learning is ended.

The merging/learning unit 233 merges the common model included in the common model information 222 and the specific model included in the specific model information 224 using the merging parameter indicated by the merging parameter information 223. For example, the merging/learning unit 233 merges the output of the i-th layer of the common model to the j-th layer of the specific model after multiplying the output of the i-th layer of the common model by a predetermined value such as the matrix Wᵢ, which is the merging parameter.

As one example, a hyperparameter ηᵢ, which indicates the strength of the merging, is determined in advance. Further, the merging/learning unit 233 receives the matrix Wᵢ, which is the merging parameter, from the server apparatus 300 via the transmission/reception unit 231 in advance. For example, the merging/learning unit 233 merges the common model and the specific model using the hyperparameter ηᵢ and the matrix Wᵢ. For example, the merging/learning unit 233 merges the common model and the specific model by multiplying the output of the i-th layer of the common model by a product of the matrix Wᵢ and ηᵢ and adding a resultant value therefrom to an output of the j-th layer of the specific model before the output of the j-th layer of the specific model passes through an activating function. Note that the merging/learning unit 233 can, for example, add the output of the common model to the output of the specific model directly. Further, the merging/learning unit 233 may add several layers subsequent to the output. Further, the hyperparameter η may be, for example, an arbitrary value equal to or greater than 0 and equal to or smaller than 1.

Further, the merging/learning unit 233 learns the merging parameter. For example, the merging/learning unit 233 learns the merging parameter using, for example, the common feature and the specific feature included in the learning data 221. As one example, the merging/learning unit 233 learns the merging parameter by conducting the horizontal federated learning similarly to the common model. For example, the merging/learning unit 233 receives the merging parameter from the server apparatus 300 via the transmission/reception unit 231. Further, after merging the common model and the specific model, the merging/learning unit 233 updates the merging parameter using, for example, the common feature and the specific feature included in the learning data 221, thereby generating a new merging parameter. Then, the merging/learning unit 233 stores the merging parameter updated/generated by the learning into the storage unit 220 as the merging parameter information 223. Further, the merging/learning unit 233 transmits, for example, the update parameter information indicating the parameter updated by the learning to the server apparatus 300 via the transmission/reception unit 231. The merging/learning unit 233 may repeat the above-described processing until the learning is ended.

The specific model learning unit 234 generates the specific model using at least the specific feature included in the learning data 221. Further, in the case of the present exemplary embodiment, the specific model learning unit 234 can learn/update the specific model so as to retain the outcome learned by the horizontal federated learning.

For example, the specific model learning unit 234 learns the specific model using the specific feature. Further, the specific model learning unit 234 learns the specific model so as to retain the outcome learned by the horizontal federated learning by conducting the learning based on at least the specific feature after inputting the output of the intermediate layer of the common model that is learned by the horizontal federated learning to each layer of the specific model. In other words, the specific model learning unit 234 conducts the learning using the common model and the specific model in a state of being merged by the merging/learning unit 233 using the common model and the merging parameter updated by the horizontal federated learning. As one example, the specific model learning unit 234 inputs the common feature to the common model and inputs the specific feature to the specific model to conduct the learning to update the specific model, thereby generating a new specific model. Then, the specific model learning unit 234 stores the specific model updated/generated by the learning into the storage unit 220 as the specific model information 224. Note that the specific model included in the specific model information 224 is specific to the learning apparatus 200. Therefore, the specific model does not have to be transmitted to the server apparatus 300 and the like.

Note that the feature used when the specific model learning unit 234 generates the specific model may include data different from the specific feature. For example, the specific model learning unit 234 may learn the specific model using both the specific feature and the common feature. The specific model learning unit 234 may learn the specific model using the specific feature and a predetermined part of the common feature. Whether the specific model learning unit 234 uses data different from the specific feature when learning the specific model may be determined by an arbitrary method.

The inference unit 235 makes an inference using the result of the learning. For example, the inference unit 235 makes an inference by inputting the common feature to the common model and also inputting the specific feature to the specific model. For example, the inference unit 235 may adopt the output of the specific model as a final inference result.

This is an example of the configuration of the learning apparatus 200.

Then, if summarized, the relationship among the common model, the specific model, and the merging parameter learned by the learning apparatus 200 is, for example, outlined as exemplarily illustrated in FIG. 5. FIG. 5 illustrates an example when the value of the hyperparameter n is 1 and the layer number is j=i+1. As illustrated in FIG. 5, as one example, the common model and specific model are merged by multiplying the output of the intermediate layer of the common model by the product of the matrix and the hyperparameter and adding the resultant value therefrom to the output of the intermediate layer of the specific model before the output of the intermediate layer of the specific model passes through the activating function. Then, if expressed by an equation, the output of the layer i of the specific model is, for example, expressed as indicated by the following equation 1.

$${h}_{i}^{p e r} = f ( {U}_{i} {h}_{i - 1}^{p e r} + {b}_{i} + {W}_{i - 1} {h}_{i - 1}^{com} ) \qquad [ Equation 1 ]$$

Note that hᵢ represents the output of the i-th layer. Further, f represents the activating function. Further, Uᵢ represents a weighting matrix of the i-th layer of the specific model, and bᵢ represents a bias of the i-th layer of the specific model. Note that per indicates that this item relates to the specific model and com indicates that this item relates to the common model in the above-described equation.

Further, in the case of the example illustrated in FIG. 5, a final output hₒᵤₜ is, for example, expressed as indicated by the following equation 2.

$${h}_{out} = {h}_{out}^{per} + {h}_{out}^{com} \qquad [ Equation 2 ]$$

This is an example of the relationship among the common model, the specific model, and the merging parameter learned by the learning apparatus 200. Note that, if the value of the hyperparameter n is set to zero, such a setting causes the intermediate layers of the common model and the specific model not to be merged and only the outputs of the common model and the specific model to be added up. Further, how the common model and the specific model are merged can be changed by changing a portion “a” in the layer number j=i+a to a value other than 1.

The server apparatus 300 is an information processing apparatus that receives the information targeted for the horizontal federated learning such as the common model, the merging parameter, and the parameter update information from the learning apparatus 200, the other learning apparatus(es) 400, and the like and performs integration processing such as averaging so as to realize the horizontal federated learning. Further, the server apparatus 300 transmits the integrated common model and merging parameter (or the parameter update information) to the learning apparatus 200 and the other learning apparatus(es) 400.

FIG. 6 illustrates an example of the configuration of the server apparatus 300. Referring to FIG. 6, the server apparatus 300 includes a transmission/reception unit 310 and an integration unit 320. For example, the server apparatus 300 includes an arithmetic device such as a CPU and a storage device, and realizes each of the above-described processing units through execution of a program stored in the storage device by the arithmetic device. Note that the server apparatus 300 may be equipped with a standard function different from the above-described examples.

The transmission/reception unit 310 receives the common model, the parameter update information of the common model, the merging parameter, the parameter update information of the merging parameter, and the like from the learning apparatus 200, the other learning apparatus(es) 400, and the like. Further, the transmission/reception unit 310 can transmit the common model, the parameter update information of the common model, the merging parameter, the parameter update information of the merging parameter, and the like to the learning apparatus 200, the other learning apparatus(es) 400, and the like.

The integration unit 320 advances the federated learning processing by integrating, for example, a plurality of common models or merging parameters received from the learning apparatus 200, the other learning apparatus(es) 400, and the like.

For example, the integration unit 320 generates the common model as the integrated model resulting from integrating the common models received from the learning apparatus 200 and the other learning apparatus(es) 400 by, for example, averaging the plurality of common models received from the learning apparatus 200 and the other learning apparatus(es) 400. Further, the integration unit 320 can transmit the integrated common model or the parameter update information of the integrated common model to the learning apparatus 200 and the other learning apparatus(es) 400 via the transmission/reception unit 310.

Further, for example, the integration unit 320 generates the merging parameter as the integrated parameter resulting from integrating the merging parameters received from the learning apparatus 200 and the other learning apparatus(es) 400 by, for example, averaging the plurality of merging parameters received from the learning apparatus 200 and the other learning apparatus(es) 400. Further, the integration unit 320 can transmit the integrated merging parameter or the parameter update information of the integrated merging parameter to the learning apparatus 200 and the other learning apparatus(es) 400 via the transmission/reception unit 310.

In this manner, the server apparatus 300 has a configuration for realizing typical horizontal federated learning by way of example. Further, in the case of the present exemplary embodiment, the server apparatus 300 may be configured to be able to conduct the horizontal federated learning with respect to not only the common model but also the merging parameter.

Note that the server apparatus 300 may be configured to determine an initially used common model and merging parameter by an arbitrary method. For example, the server apparatus 300 may be configured to learn the initial common model using only a common feature on a cloud and transmit the learned common model to the learning apparatus 200 and the other learning apparatus(es) 400.

The other learning apparatus(es) 400 is/are each an information processing apparatus that has at least a function for conducting the horizontal federated learning with respect to the above-described common model. Further, at least a part of the other learning apparatuses 400 has a function for learning the above-described specific model in addition to the function for conducting the horizontal federated learning with respect to the common model. In other words, at least a part of the other learning apparatuses 400 included in the learning system 100 can have a configuration similar to the configuration provided to the above-described learning apparatus 200. The configuration of the learning apparatus 200 has been already described, and therefore the specific configuration of the other learning apparatus(es) 400 will not be described herein.

This is an example of the configuration of the learning system 100. Subsequently, examples of operations of the learning apparatus 200 will be described with reference to FIGS. 7 and 8.

FIG. 7 is a flowchart illustrating an example of an operation of the learning apparatus 200. Referring to FIG. 7, the learning apparatus 200 determines the hyperparameter n using an arbitrary method (step S110). The hyperparameter n may be determined in advance.

Further, the learning apparatus 200 determines a feature to input to the specific model using an arbitrary method (step S120). For example, the learning apparatus 200 can determine to input only the specific feature to the specific model. The type of the feature to be input to the specific model may be determined in advance.

The common model learning unit 232 updates the parameter of the common model using the horizontal federated learning method by, for example, communicating with the server apparatus 300 via the transmission/reception unit 231 and also conducting the learning using the common feature (step S130). The details of the processing of step S130 will be described below.

The merging/learning unit 233 merges the common model and the specific model using the merging parameter W and the hyperparameter n (step S140). For example, the merging/learning unit 233 merges the common model and the specific model by multiplying the output of the i-th layer of the common model by the product of the matrix Wᵢ and ni and adding the resultant value therefrom to the output of the j-th layer of the specific model before the output of the j-th layer of the specific model passes through the activating function.

Further, the merging/learning unit 233 updates the merging parameter W using the horizontal federated learning method (step S150). The merging parameter may be updated using the horizontal federated learning in a similar manner to step S130.

The specific model learning unit 234 learns/updates the specific model so as to retain the outcome learned by the horizontal federated learning (step S160). For example, the specific model learning unit 234 conducts the learning using the common model and the specific model in the state of being merged by the merging/learning unit 233 using the common model and the merging parameter updated by the horizontal federated learning. By that, the specific model learning unit 234 updates the parameter of the specific model.

The learning apparatus 200 repeats the processing from step S130 to step S160 until the learning is ended (step S170). According to the end of the learning (step S170, YES), the learning apparatus 200 ends the processing.

FIG. 8 is a flowchart illustrating a detailed example of the processing of step S130. Referring to FIG. 8, the transmission/reception unit 231 receives the common model from the server apparatus 300 (step S1331). For example, the transmission/reception unit 231 may receive the common model by requesting the server apparatus 300 to transmit the common model or may receive the common model from the server apparatus 300 in advance.

The common model learning unit 232 generates a new common model by updating the common model using the common feature included in the learning data 221 (step S132). Further, the common model learning unit 232 transmits, for example, the update parameter information indicating the parameter updated by the learning to the server apparatus 300 via the transmission/reception unit 231 (step S133).

The transmission/reception unit 231 and the common model learning unit 232 can repeat the processing from step S131 to step S133 until the learning is ended (step S134). According to the end of the learning (step S134, YES), the transmission/reception unit 231 and the common model learning unit 232 end the processing of step S130.

In this manner, the learning apparatus 200 includes the common model learning unit 232 and the specific model learning unit 234. Due to such a configuration, the specific model learning unit 234 can learn the specific model so as to retain the outcome learned by the horizontal federated learning using the common model learning unit 232. As a result, the learning can be conducted using not only the common feature but also the specific feature, which is a feature unable to be utilized when the horizontal federated learning is conducted. Due to that, for example, the inference accuracy can be further increased.

Note that the present exemplary embodiment has been described referring to the example when the learning of the common model using the horizontal federated learning and the learning of the specific model are individually alternately conducted. However, the learning apparatus 200 may be configured to conduct the learning of the common model and the learning of the specific model all at once as exemplarily illustrated in FIG. 9. When conducting the learning of the common model and the learning of the specific model all at once, for example, the learning apparatus 200 determines a hyperparameter γ in addition to the hyperparameter n using an arbitrary method (step S210). For example, the hyperparameter γ may be, for example, an arbitrary value equal to or greater than 0. Further, the learning apparatus 200 determines a feature to input to the specific model using an arbitrary method (step S220). Subsequently, the merging/learning unit 233 of the learning apparatus 200 merges the common model and the specific model by a method similar to the method described in the present exemplary embodiment, such as multiplying the output of the i-th layer of the common model by the product of the matrix Wᵢ and ηᵢ and adding the resultant value therefrom to the output of the j-th layer of the specific model before the output of the j-th layer of the specific model passes through the activating function (step S230). After that, assuming that L represents a loss function regarding the final output of the specific model and L₁ represents a loss function regarding the output of the common model, the learning apparatus 200 updates the specific model, the common model, and the merging parameter Wᵢ all at once by minimizing L+γL₁ (step S240). At this time, the common model and the merging parameter Wᵢ are updated by the horizontal federated learning. Then, the learning apparatus 200 repeats the merging and update processing until the learning is ended (step S250). The learning apparatus 200 may be configured to conduct the learning of the common model and the learning of the specific model all at once by such a method by way of example. Note that, generally, the accuracy is more increased when the learning of the common model and the learning of the specific model are individually alternately conducted.

Further, the present exemplary embodiment has been described referring to the example when the learning is conducted by merging, for example, the intermediate layer of the common model and the intermediate layer of the specific model using the merging parameter and the like as one method for learning the specific model so as to retain the outcome learned by the horizontal federated learning. However, the learning apparatus 200 may be configured to learn the specific model so as to retain the outcome learned by the horizontal federated learning using a commonly-used continual learning method different from the method exemplified in the present exemplary embodiment. Further, the learning apparatus 200 may be configured to update only the common model by the horizontal federated learning.

Further, the present exemplary embodiment has been described referring to the example when the learning system 100 includes the server apparatus 300 and conducts the horizontal federated learning using the server apparatus 300. However, the learning system 100 does not necessarily have to include the server apparatus 300. In the case where the learning system 100 does not include the server apparatus 300, the learning apparatus 200 is supposed to conduct the horizontal federated learning by transmitting/receiving the common model, the merging parameter, the parameter update information, and the like to and from the other learning apparatus(es) 400 directly.

### Second Exemplary Embodiment

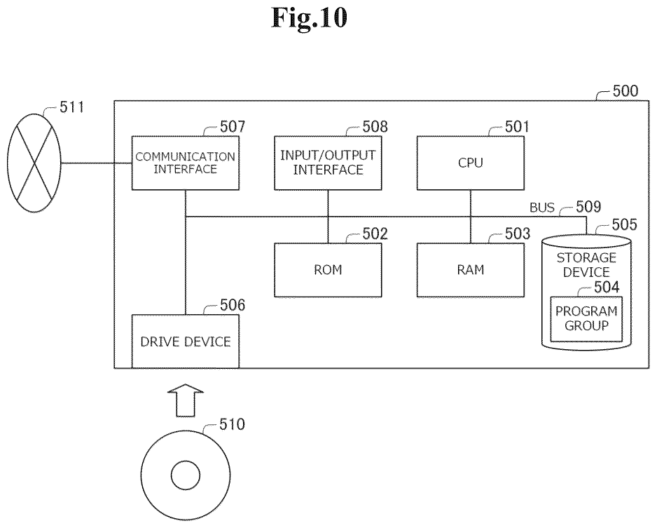

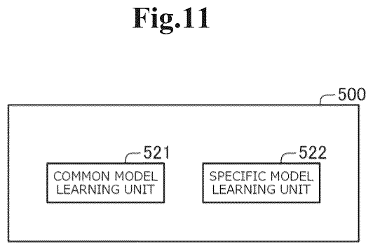

Next, a second exemplary embodiment of the present invention will be described with reference to FIGS. 10 and 11. FIGS. 10 and 11 illustrate an example of the configuration of a learning apparatus 500.

FIG. 10 illustrates an example of the hardware configuration of the learning apparatus 500, which is an information processing apparatus. Referring to FIG. 10, the learning apparatus 500 has the following hardware configuration as one example.
CPU (Central Processing Unit) 501 (arithmetic device)
ROM (Read Only Memory) 502 (storage device)
RAM (Random Access Memory) 503 (storage device)
Program group 504 to be loaded into the RAM 503
Storage device 505 storing therein the program group 504
Drive device 506 that performs reading and writing on a recording medium 510 outside the information processing apparatus
Communication interface 507 connected to a communication network 511 outside the information processing apparatus
Input/output interface 508 that inputs and outputs data
Bus 509 connecting each constituent element

Further, the learning apparatus 500 can realize functions as a common model learning unit 521 and a specific model learning unit 522 illustrated in FIG. 11 through acquisition of the program group 504 by the CPU 501 and execution thereof by this CPU 501. Note that the program group 504 is, for example, stored in the storage device 505 or the ROM 502 in advance, and loaded into the RAM 503 or the like and executed by the CPU 501 as needed. Alternatively, the program group 504 may be supplied to the CPU 501 via the communication network 511, or may be stored in the recording medium 510 in advance and read out by the drive device 506 and supplied to the CPU 501.

Note that FIG. 10 illustrates an example of the hardware configuration of the learning apparatus 500. The hardware configuration of the learning apparatus 500 is not limited to the above-described example. For example, the learning apparatus 500 may be configured of a part of the above-described configuration, such as a configuration not including the drive device 506.

The specific model learning unit 521 learns a common model in cooperation with an other learning apparatus using a common feature, which is a feature owned in common with the other learning apparatus, among features owned by this learning apparatus 500. In other words, the common model learning unit 521 learns the common model by federated learning.

The specific model learning unit 522 learns a specific model, which is a model specific to this learning apparatus 500, using a specific feature, which is a feature not owned in common with the other learning apparatus, among the features owned by this learning apparatus 500 so as to retain an outcome learned by the common model learning unit 621 in cooperation with the other learning apparatus based on the common model learned by the common model learning unit 521.

In this manner, the learning apparatus 500 includes the specific model learning unit 522. According to such a configuration, the specific model learning unit 522 can learn the specific model using the specific feature so as to retain the outcome learned by the common model learning unit 621 in cooperation with the other learning apparatus. As a result, the learning can be conducted using not only the common feature but also the specific feature, which is a feature unable to be utilized when the federated learning is conducted. Due to that, for example, the inference accuracy can be further increased.

Note that the above-described learning apparatus 500 can be realized by incorporating a predetermined program into an information processing apparatus such as this learning apparatus 500. More specifically, a program according to another aspect of the present invention is a program for realizing processing including causing an information processing apparatus such as the learning apparatus 500 to learn a common model in cooperation with an other learning apparatus using a common feature, which is a feature owned in common with the other learning apparatus, among features owned by this learning apparatus 500, and learn a specific model, which is a model specific to this learning apparatus 500, using a specific feature, which is a feature not owned in common with the other learning apparatus, among the features owned by this learning apparatus 500 so as to retain an outcome learned in cooperation with the other learning apparatus based on the learned common model.

Further, a learning method configured to be performed by an information processing apparatus such as the above-described learning apparatus 500 is a method including causing the information processing apparatus such as the learning apparatus 500 to learn a common model in cooperation with an other learning apparatus using a common feature, which is a feature owned in common with the other learning apparatus, among features owned by this learning apparatus 500, and learn a specific model, which is a model specific to this learning apparatus 500, using a specific feature, which is a feature not owned in common with the other learning apparatus, among the features owned by this learning apparatus 500 so as to retain an outcome learned in cooperation with the other learning apparatus based on the learned common model.

Even the invention of the program or a non-transitory computer-readable recording medium recording the program, or the learning method configured in the above-described manner can also bring about functions and advantageous effects similar to the above-described learning apparatus 500, thereby achieving the above-described object of the present invention.

### Supplementary Notes

A part or whole of the above-described exemplary embodiments can also be described as, but not limited to, the following supplementary notes. In the following description, the outline of the learning apparatus and the like according to the present invention will be described. However, the present invention is not limited to the following configurations.

### Supplementary Note 1

A learning apparatus comprising:
a common model learning unit configured to learn a common model using a common feature among features owned by this learning apparatus, the common model being also used by an other learning apparatus, the common feature being a feature owned in common with the other learning apparatus; and
a specific model learning unit configured to learn a specific model using a specific feature among the features owned by this learning apparatus based on the common model learned by the common model learning unit, the specific model being a model specific to this learning apparatus, the specific feature being a feature not owned in common with the other learning apparatus.

### Supplementary Note 2

The learning apparatus according to supplementary note 1, wherein
the specific model learning unit learns the specific model by conducting learning using a continual learning method.

### Supplementary Note 3

The learning apparatus according to supplementary note 1 or 2, wherein the specific model learning unit learns the specific model by conducting learning using the specific feature after inputting an output of an intermediate layer of the common model learned by the common model learning unit to each layer of the specific model.

### Supplementary Note 4

The learning apparatus according to any one of supplementary notes 1 to 3, further comprising:
a merging unit configured to merge the common model and the specific model using a predetermined merging parameter,
wherein the specific model learning unit conducts learning using the common model and the specific model merged by the merging unit.

### Supplementary Note 5

The learning apparatus according to supplementary note 4, wherein
the merging unit merges the common model and the specific model by multiplying the output of the intermediate layer of the common model by a value based on the merging parameter and adding a resultant value therefrom to an output of an intermediate layer of the specific model before the output of the intermediate layer of the specific model passes through an activating function.

### Supplementary Note 6

The learning apparatus according to supplementary note 4 or 5, wherein
the merging unit learns the merging parameter in cooperation with the other learning apparatus.

### Supplementary Note 7

The learning apparatus according to any one of supplementary notes 1 to 6, further comprising:
an inference unit configured to make an inference by inputting the common feature to the common model and also inputting the specific feature to the specific model.

### Supplementary Note 8

A learning method comprising:
causing an information processing apparatus to
learn a common model using a common feature among features owned by this information processing apparatus, the common model being also used by an other learning apparatus, the common feature being a feature owned in common with the other learning apparatus, and
learn a specific model using a specific feature among the features owned by this information processing apparatus based on the learned common model, the specific model being a model specific to this information processing apparatus, the specific feature being a feature not owned in common with the other learning apparatus.

### Supplementary Note 9

A non-transitory computer-readable recording medium recording thereon a program for realizing processing comprising:
causing an information processing apparatus to
learn a common model using a common feature among features owned by this information processing apparatus, the common model being also used by an other learning apparatus, the common feature being a feature owned in common with the other learning apparatus, and
learn a specific model using a specific feature among the features owned by this information processing apparatus based on the learned common model, the specific model being a model specific to this information processing apparatus, the specific feature being a feature not owned in common with the other learning apparatus.

### Supplementary Note 10

A learning system comprising:
a learning apparatus including
a common model learning unit configured to learn a common model using a common feature among features owned by this learning apparatus, the common model being also used by an other learning apparatus, the common feature being a feature owned in common with the other learning apparatus, and
a specific model learning unit configured to learn a specific model using a specific feature among the features owned by this learning apparatus based on the common model learned by the common model learning unit, the specific model being a model specific to this learning apparatus, the specific feature being a feature not owned in common with the other learning apparatus; and
a server apparatus including an integration unit configured to, by communicating with a plurality of learning apparatuses, integrate the common model learned by each of the learning apparatuses.

Having described the present invention with reference to each of the above-described exemplary embodiments, the present invention is not limited to the above-described exemplary embodiments. The form and details of the present invention can be changed within the scope of the present invention in various manners that can be understood by those skilled in the art.

### REFERENCE SIGNS LIST

100 learning system
200 learning apparatus
210 communication I/F unit
220 storage unit
221 learning data
222 common model information
223 merging parameter information
224 specific model information
225 program
230 arithmetic processing unit
231 transmission/reception unit
232 common model learning unit
233 merging/learning unit
234 specific model learning unit
300 server apparatus
310 transmission/reception unit
320 integration unit
400 other learning apparatus
500 learning apparatus
501 CPU
502 ROM
503 RAM
504 program group
505 storage device
506 drive device
507 communication interface
508 input/output interface
509 bus
510 recording medium
511 communication network
521 common model learning unit
522 specific model learning unit

What is claimed is:

1. A learning apparatus comprising:
at least one memory configured to store processing instructions; and
at least one processor configured to execute the processing instructions to:
learn a common model using a common feature among features owned by this learning apparatus, the common model being also used by an other learning apparatus, the common feature being a feature owned in common with the other learning apparatus; and
learn a specific model using a specific feature among the features owned by this learning apparatus based on the common model learned by the common model learning unit, the specific model being a model specific to this learning apparatus, the specific feature being a feature not owned in common with the other learning apparatus.

2. The learning apparatus according to claim 1, wherein
the at least one processor configured to execute the processing instructions learns the specific model by conducting learning using a continual learning method.

3. The learning apparatus according to claim 1,
wherein the at least one processor configured to execute the processing instructions learns the specific model by conducting learning using the specific feature after inputting an output of an intermediate layer of the common model learned by the common model learning unit to each layer of the specific model.

4. The learning apparatus according to claim 1, wherein
the at least one processor configured to execute the processing instructions merges the common model and the specific model using a predetermined merging parameter, and
conducts learning using the common model and the-specific model that have been merged.

5. The learning apparatus according to claim 4, wherein
the at least one processor configured to execute the processing instructions merges the common model and the specific model by multiplying the output of the intermediate layer of the common model by a value based on the merging parameter and adding a resultant value therefrom to an output of an intermediate layer of the specific model before the output of the intermediate layer of the specific model passes through an activating function.

6. The learning apparatus according to claim 4, wherein
the at least one processor configured to execute the processing instructions
learns the merging parameter in cooperation with the other learning apparatus.

7. The learning apparatus according to claim 1, wherein
the at least one processor configured to execute the processing instructions
makes an inference by inputting the common feature to the common model and also inputting the specific feature to the specific model.

8. A learning method comprising:
causing an information processing apparatus to
learn a common model using a common feature among features owned by this information processing apparatus, the common model being also used by an other learning apparatus, the common feature being a feature owned in common with the other learning apparatus, and
learn a specific model using a specific feature among the features owned by this information processing apparatus based on the learned common model, the specific model being a model specific to this information processing apparatus, the specific feature being a feature not owned in common with the other learning apparatus.

9. A non-transitory computer-readable recording medium recording thereon a program for realizing processing comprising:
causing an information processing apparatus to
learn a common model using a common feature among features owned by this information processing apparatus, the common model being also used by an other learning apparatus, the common feature being a feature owned in common with the other learning apparatus, and
learn a specific model using a specific feature among the features owned by this information processing apparatus based on the learned common model, the specific model being a model specific to this information processing apparatus, the specific feature being a feature not owned in common with the other learning apparatus.

10. (canceled)
